(19) United States
(12) Patent Application Publication
(10) Pub. No.: US 2026/0145592 A1
(43) Pub. Date: May 28, 2026

(54) Locking Assembly for Pivot Seat Base Assembly

(71) Applicant: DEMERS, AMBULANCE MANUFACTURER INC./ DEMERS, MANUFACTURIER D’AMBULANCES INC., Beloeil (CA)

(72) Inventor: Gilbert Dubocquet, Saint-Jean-sur-Richelieu (CA)

(21) Appl. No.: 19/395,591

(22) Filed: Nov. 20, 2025

Related U.S. Application Data
(60) Provisional application No. 63/723,857, filed on Nov. 22, 2024.

(51) Int. Cl. B60N 2/14

(52) U.S. Cl. CPC B60N 2/146

(57) ABSTRACT

A locking assembly for a pivot assembly is provided. The pivot assembly includes a first pivot member having a circular opening and a second pivot member having a first shaft coaxially mounted within the circular opening for relative pivot movement of the first and second pivot members. The locking assembly includes pressure elements mounted within the circular opening to one of the pivot members and biased toward the other pivot member to prevent relative pivot movement, and an actuating mechanism configured to selectively move the pressure elements away from the other pivot member. In certain embodiments, the pressure elements comprise dowel pins mounted by springs to a mounting disk, and the actuating mechanism includes dowel-contacting fingers and an actuating element movable between locking and unlocking positions. The locking assembly can form part of a multi-pivot seat base assembly for vehicles and can be combined with a blocking system having pulleys, a flexible tension member, and blocking cleats to prevent unwanted movement for example during emergency conditions.

### CROSS REFERENCE TO RELATED PATENT APPLICATION

This application claims the benefit of U.S. Provisional Application No. 63/723,857, filed on Nov. 22, 2024, the content of which is incorporated by reference herein.

### FIELD

The present disclosure relates to seat bases. More specifically, the present disclosure is concerned with a locking assembly for a single or multi-pivot seat base assembly.

### BACKGROUND

Many vehicles, such as emergency vehicles and transport vehicles, are provided with seats that are fixedly mounted to the floor of the vehicle via seat bases.

In some cases, the seat bases are mounted onto tracks, fixed on, above or embedded in the floor of the vehicle, to allow some restricted movements of the seat occupants. These tracks have many drawbacks, including the fact that foreign matters may be stuck therein and prevent desired movements or that each axis of movement requires a different release mechanism, making repositioning a multi-movement operation. Furthermore, they can become trip hazards.

Multi-pivot seat bases, such as those described in U.S. Pat. No. 12,325,333, issued on Jun. 10, 2025, and in International Publ. No. WO 2023/242778, published on Dec. 21, 2023, both naming Dubocquet et al. as the inventors, and both titled “Multi-Pivot Seat Base Assembly” solve the above drawbacks.

Both assemblies by Dubocquet et al. include pivotable proximate and distal arms and locking assemblies to selectively prevent the pivot of these arms, for example to stabilize the position of the user, or in case of an accident involving the vehicle.

Drawbacks of the locking assemblies from Dubocquet et al., which involve the use of gears, include the complexity of synchronizing the alignment of gear teeth in the locking assemblies and of the pressure thereon. Also, they do not allow infinite resolution in the movement and conventional slack in the gears.

### SUMMARY

According to illustrative embodiments, there is provided a locking assembly for a pivot assembly that includes a first pivot member having a circular opening therein, and a second pivot member having a first shaft coaxially mounted in the circular opening of the first pivot member for relative pivot movement of the first and second pivot members, the locking assembly comprising:
pressure elements mounted, within the circular opening, to one of the first and second pivot members; the pressure elements being biased towards the other one of the first and second pivot members to prevent said relative pivot movement; and
an actuating assembly, mounted to the pressure elements, that selectively moves the pressure elements away from the other one of the first and second pivot members; the actuating assembly including a second shaft that is positioned and movable coaxially to both the first shaft and circular opening to cause the pressure elements to move away from the other one of the first and second pivot members.

According to another aspect a pivot seat base assembly is provided which comprises:
first and second pivot assemblies;
a blocking system comprising:
a) a fairlead pulley fixedly mounted to the first pivot assembly;
b) a dynamic pulley fixedly mounted to the second pivot assembly;
c) a flexible tension member that is operatively mounted to both the fairlead and dynamic pulleys therein; and
d) blocking cleats mounted to the fairlead pulley for movement between a default position, wherein a rotation of the dynamic pulley via the flexible tension member is prevented, and an actuated position, wherein the rotation of the dynamic pulley is allowed;
wherein, one of the first and second pivot assemblies including a locking assembly as above.

According to further illustrative embodiments, there is provided a pivot assembly comprising:
a first pivot member having a circular opening therein,
a second pivot member having a first shaft coaxially mounted in the circular opening of the first pivot member for relative pivot movement of the first and second pivot members;
pressure elements mounted, within the circular opening, to one of the first and second pivot members, that are biased towards the other one of the first and second pivot members to prevent said relative pivot movement; and
an actuating mechanism, mounted to the pressure elements, that selectively moves the pressure elements away from the other one of the first and second pivot members; the actuating assembly including a second shaft that is positioned and movable coaxially to both the first shaft and circular opening to cause the pressure elements to move away from the other one of the first and second pivot members.

According to still other illustrative embodiments, there is provided a blocking system for a pivot seat base assembly having first and second pivot assemblies; the emergency blocking system comprising:
a) a fairlead pulley fixedly mounted to the first pivot assembly;
b) a dynamic pulley fixedly mounted to the second pivot assembly;
c) a flexible tension member that is operatively mounted to both the fairlead and dynamic pulleys therein; and
d) blocking cleats mounted to the fairlead pulley for movement between a default position, wherein a rotation of the dynamic pulley via the flexible tension member is prevented, and an actuated position, wherein the rotation of the dynamic pulley is allowed.

Other objects, advantages and features of locking assembly for a pivot seat base assembly will become more apparent upon reading the following non-restrictive description of preferred embodiments thereof, given by way of example only with reference to the accompanying drawings.

### BRIEF DESCRIPTION OF THE DRAWINGS

### In the Appended Drawings:

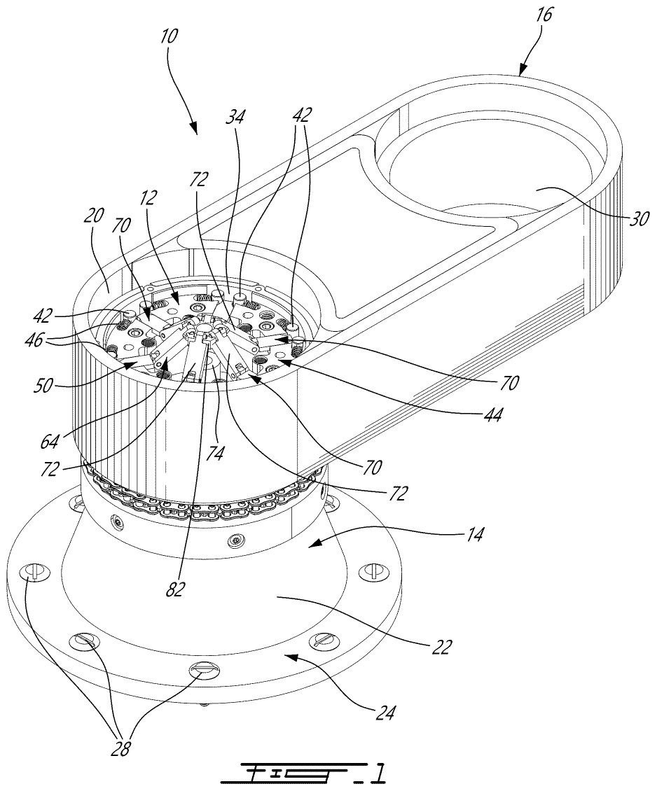

FIG. 1 is a perspective view of a pivot assembly, including a pivot locking assembly, both according to a first illustrative embodiment; the pivot assembly being shown in a locked configuration;

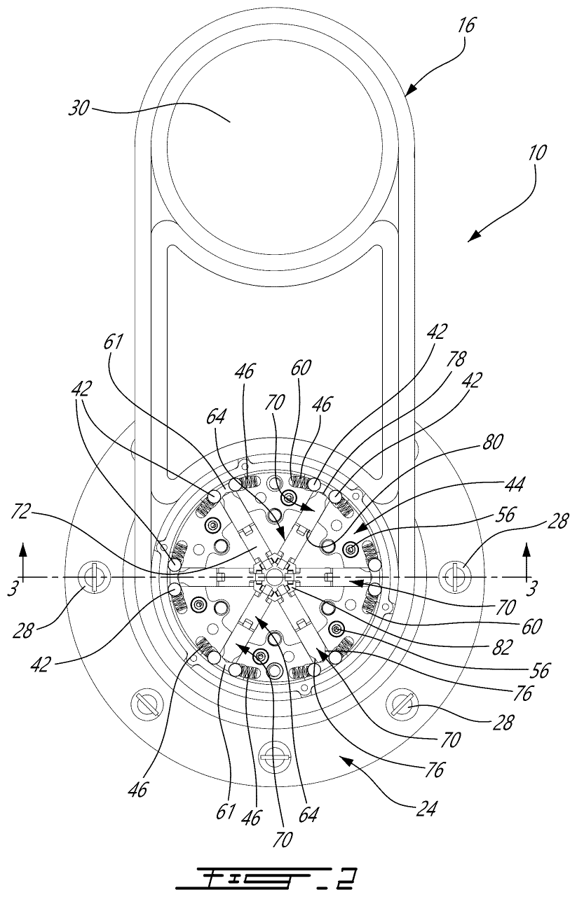

FIG. 2 is a top plan view of the pivot assembly from FIG. 1;

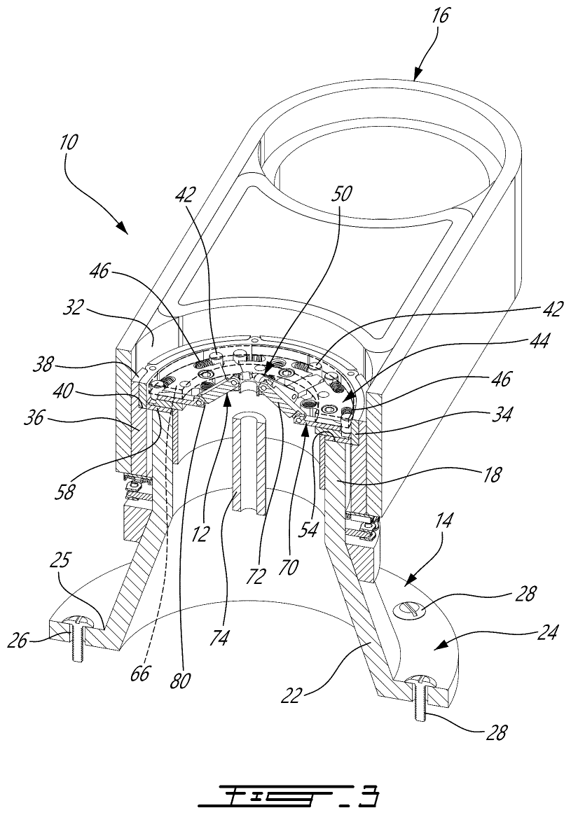

FIG. 3 is a perspective cross section taken along line 3-3 in FIG. 2;

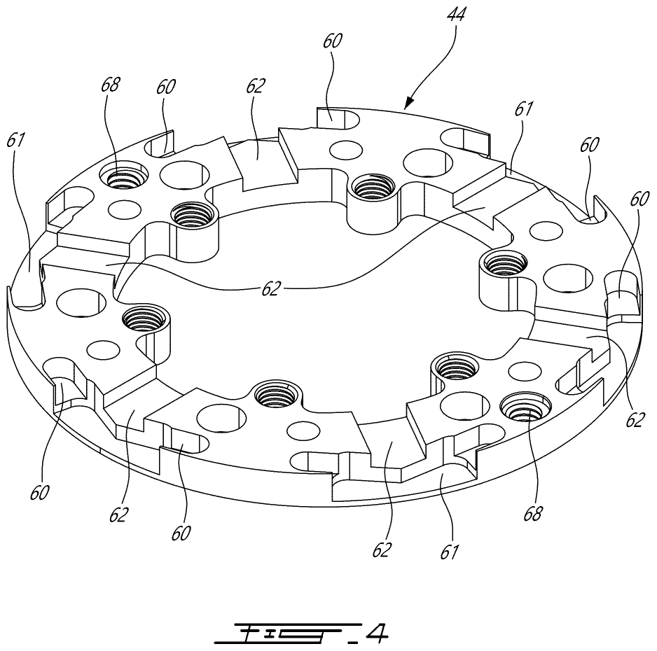

FIG. 4 is a perspective view of the mounting disk of the locking assembly;

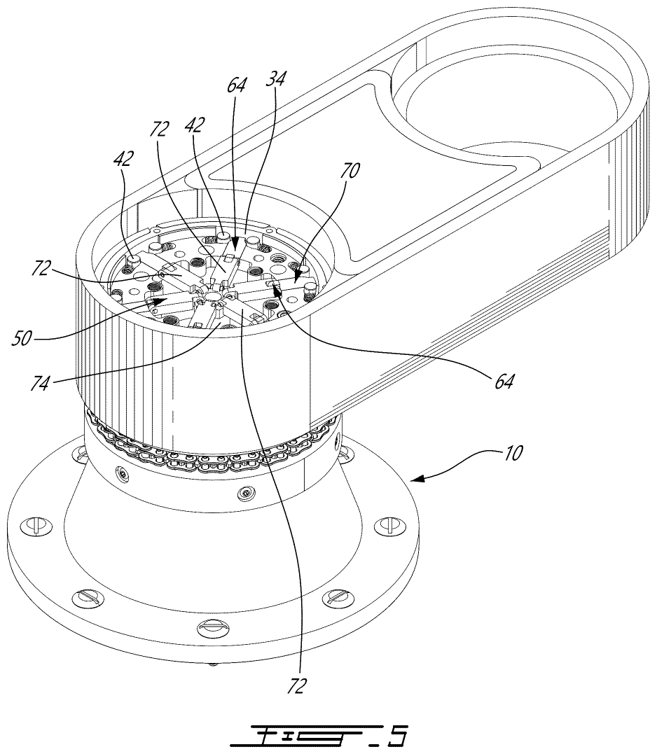

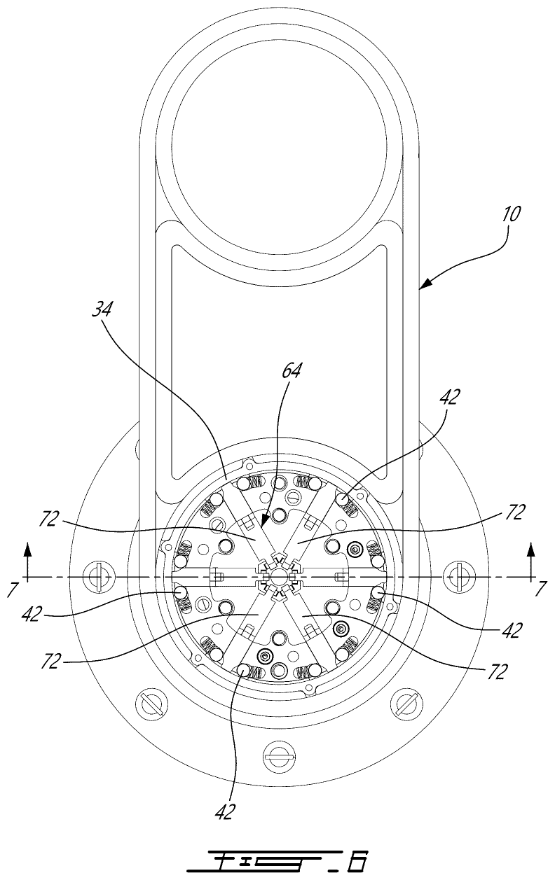

FIGS. 5 and 6 are respectively a perspective and a top plan view of the pivot assembly from FIG. 1, shown in an unlocked configuration;

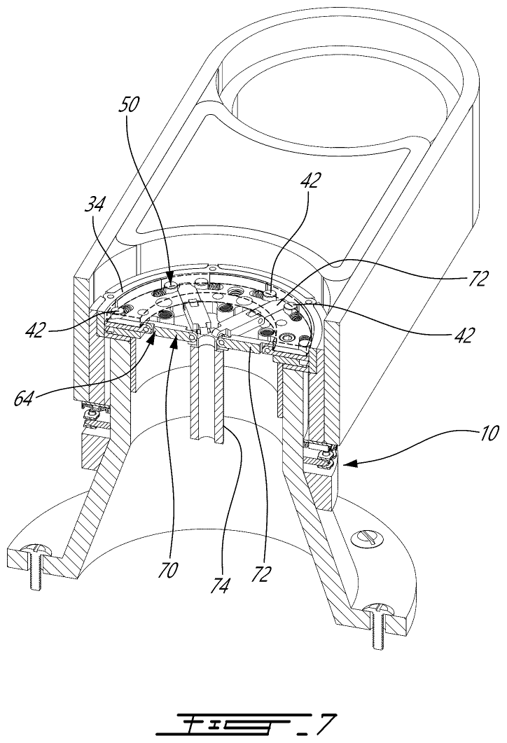

FIG. 7 is a perspective cross section taken along the line 7-7 in FIG. 6;

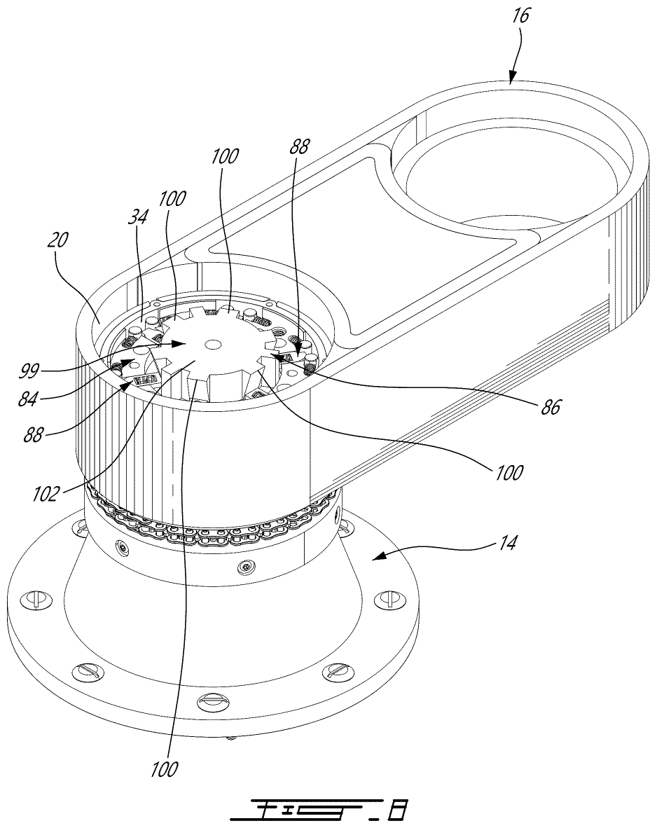

FIG. 8 is a perspective view of a pivot assembly, including a pivot locking assembly, both according to a second illustrative embodiment; the pivot assembly being shown in a locked configuration;

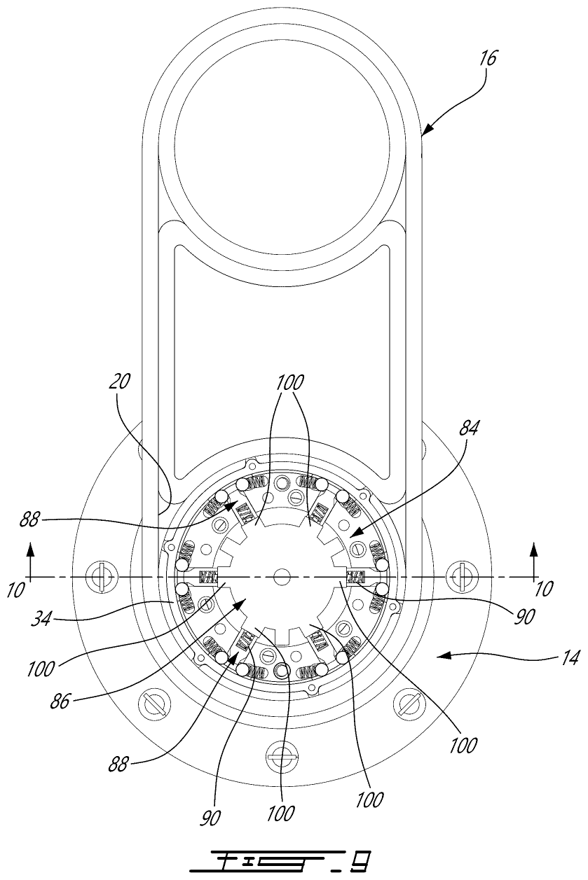

FIG. 9 is a top plan view of the pivot assembly from FIG. 8;

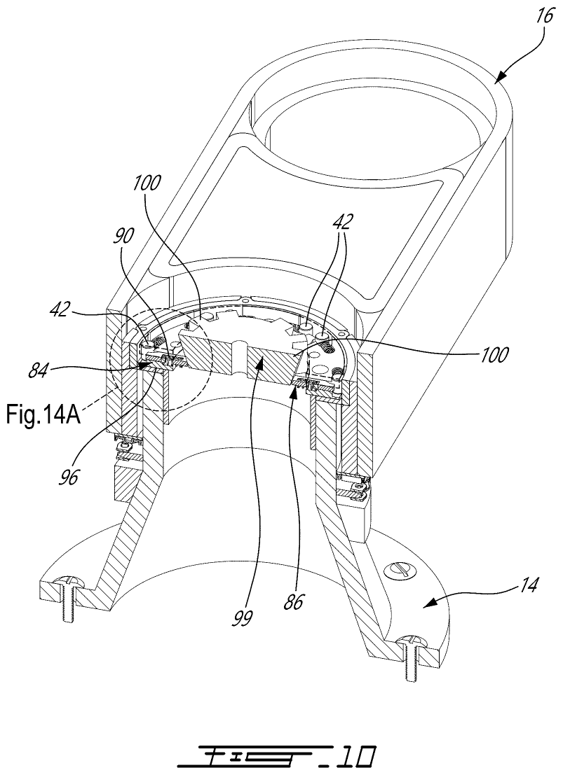

FIG. 10 is a perspective cross section taken along the line 10-10 in FIG. 9;

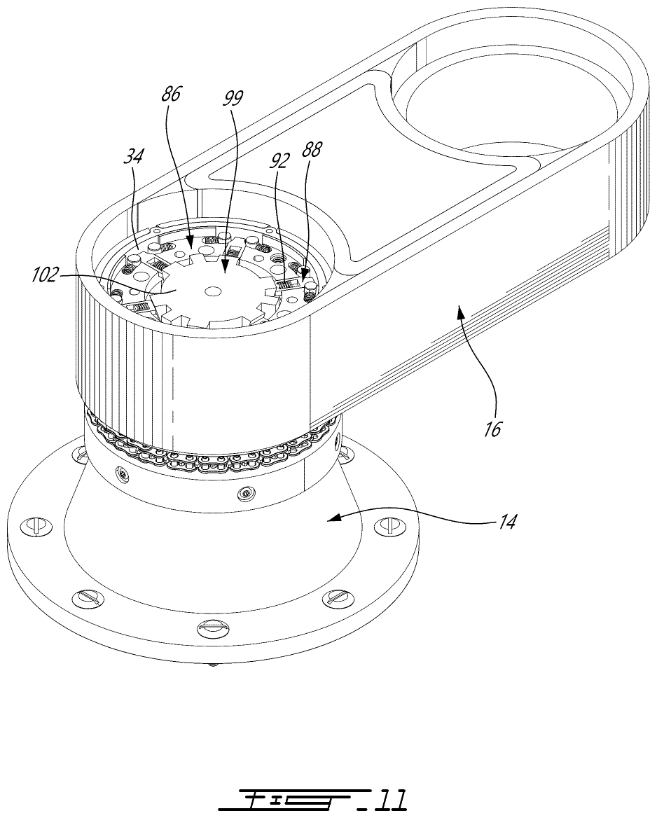

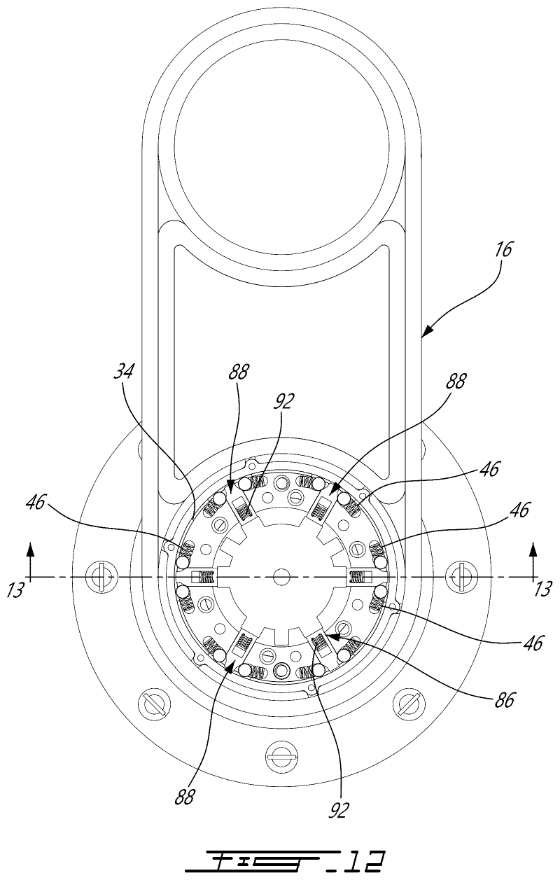

FIGS. 11 and 12 are respectively perspective and top plan views of the pivot assembly from FIG. 8, shown in an unlocked configuration;

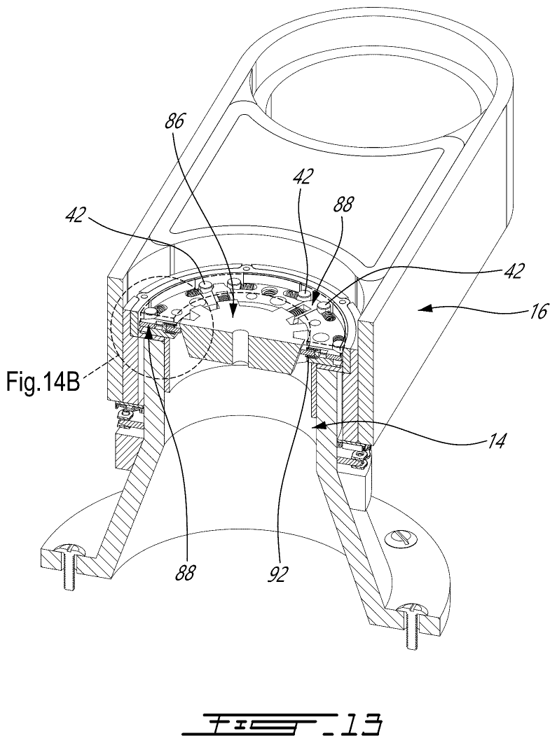

FIG. 13 is a perspective cross section taken along the line 13-13 in FIG. 12;

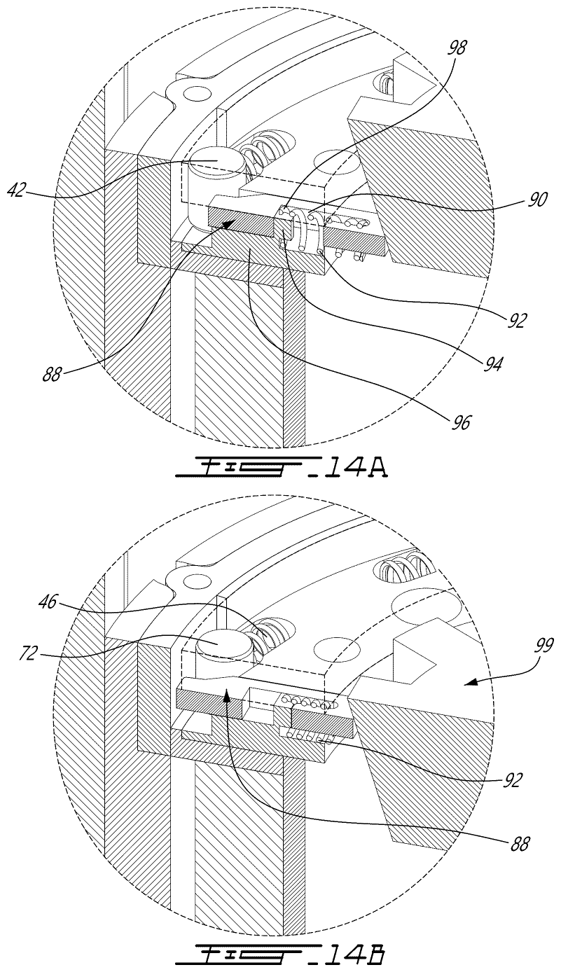

FIGS. 14A and 14B are closeup views of respectively FIGS. 10 and 13, showing part of the locking mechanism and the operation thereof; and

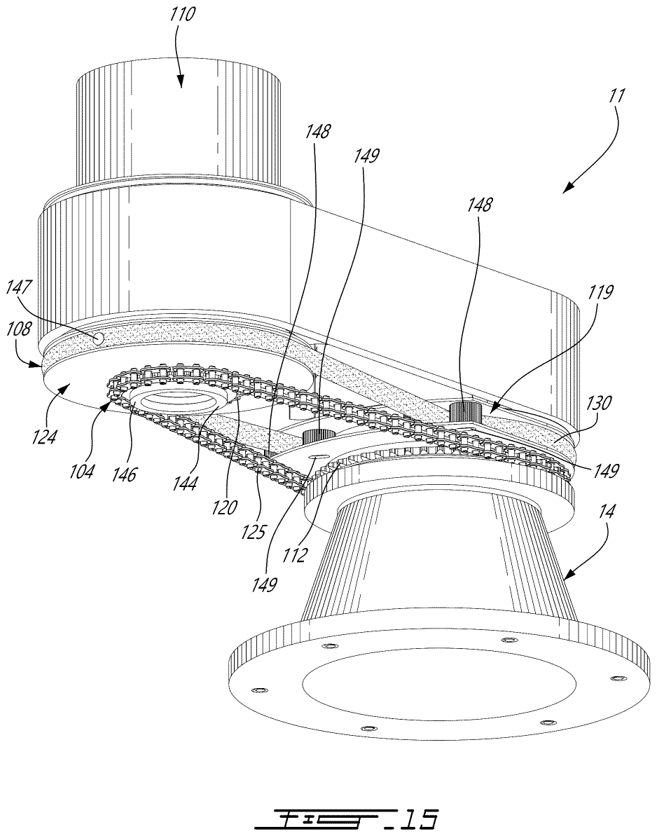

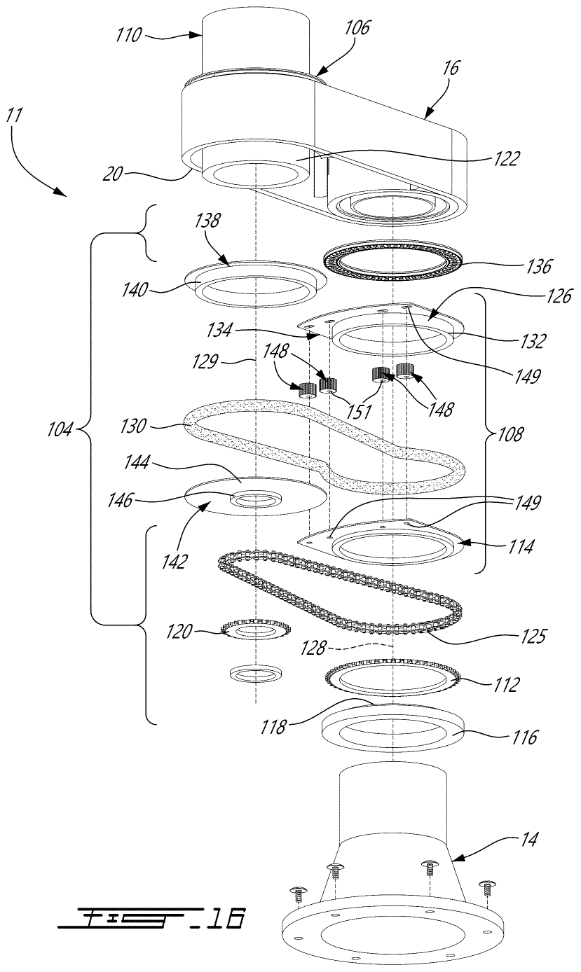

FIGS. 15 and 16 are respectively perspective and exploded views of a pivot seat base assembly provided with a pivot arm coupling assembly according to a first illustrative embodiment and a blocking system according to a second illustrative embodiment.

### DETAILED DESCRIPTION

In the following description, similar features in the drawings have been given similar reference numerals, and in order not to weigh down the figures, some elements are not referred to in some figures if they were already identified in a precedent figure. Herein, it shall further be noted that, for avoiding unnecessary details obscuring the invention, only device structures and/or processing steps closely relevant to schemes according to the invention are shown in the accompanying drawings while omitting other details less relevant to the invention.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “container” (and any form of container, such as “contain” and “contains”), are inclusive or open-ended and do not exclude additional, un-recited elements.

In the present specification and in the appended claims, various terminologies which are directional, geometrical and/or spatial in nature such as “longitudinal”, “horizontal”, “front”, rear”, “upwardly”, “downwardly”, etc. is used. It is to be understood that such terminology is used for ease of description and in a relative sense only and is not to be taken in any way as a limitation upon the scope of the present disclosure.

The expression “connected” should be construed herein and in the appended claims broadly to include any cooperative or passive association between mechanical parts or components. For example, such parts may be assembled by direct coupling or indirectly coupled using further parts.

With reference first to FIGS. 1-4, a pivot assembly 10 comprising a pivot locking assembly 12, both according to first illustrative embodiments, will now be described.

The pivot assembly 10 is part of a multi-pivot seat base assembly 11 (see FIGS. 15 and 16) that is installed in an emergency vehicle (not shown), such a multi-pivot seat base assembly 11 being designed to be fixed to the floor or to another structure of a vehicle (not shown). The multi-pivot base seat base assembly 11 can include proximate and distal arms hinged together by pivot assemblies and optional mechanisms allowing their movements to be coordinated

It is to be noted that while the present detailed description refers to an emergency vehicle such as an ambulance, other vehicles using for example seats that are fixedly or adjustably mounted to a floor using a base can be provided with a multi-pivot base as described herein.

Even though the locking assembly 12 is shown and described herein as part of a pivot assembly for a multi-pivot seat base, it can be integrated in any pivot assembly which requires selective locking thereof.

The locking assembly 12 is provided to allow locking of the pivot assembly 10. Such a locking assembly 12 may be controlled, for example, by the user or by a controller (not shown) when a position change is required.

The pivot assembly 10 comprises a first pivot member in the form of a floor-mountable shaft 14, and a second pivot member, in the form of a pivot arm 16 of the multi-pivot seat base assembly 11.

The floor-mountable shaft 14 is in the form of a one-piece body having a straight portion 18 for coaxially receiving a first circular opening 20 in the pivot arm 16 thereabout, a conical support portion 22 extending downwardly from the straight portion 18, and a mounting flange 24, extending from the conical support portion 22 at the bottom end 25 thereof. Flange 24 includes fastener-receiving holes 26 allowing mounting the shaft 14 to the floor of a vehicle (not shown) using fasteners 28.

The pivot arm 16 is a symmetrical oval-shaped body including, the first circular opening 20 and a second, identical, circular opening 30. Each of the first and second circular openings 20 and 30 includes first, second and third regular sections 32-36 that are successively narrower, and which define first and second shoulder portions 38-40.

As mentioned hereinabove, the first and second pivot members 14 and 16 according to the first illustrative embodiment are part of a multi-pivot base seat assembly, and as such, the second circular opening 30 is provided to receive the shaft portion of a third pivot member (not shown).

An illustrative embodiment of a locking assembly for a pivot assembly is not limited to any number of adjacent pairs of pivot members as it is installed between two such adjacent pivot members, as will now be described in more detail. Also, it is believed to be within the reach of a person skilled in the art to adapt such a locking assembly to the configurations and sizes of other pivot members.

The pivot arm is not limited to the illustrative embodiment 16 and may assume other configurations (not shown) that include a shaft-receiving opening, thereby defining a pivot assembly in cooperation with the shaft 14 or another shaft. A person skilled in the art will appreciate that, in alternative embodiments, the pivot arm may instead be provided with a shaft configured for insertion into a corresponding opening of another component so as to form the pivot assembly.

The locking assembly 12 comprises i) a plurality of pressure elements, in the form dowel pins 42, which are mounted to the shaft 14 via a mounting disk 44, ii) a plurality of biasing elements 46, in the form of small springs, each for biasing a respective pressure element 42 towards the facing wall portion 34 of the opening 20, and an actuating mechanism 50 that is mounted to the shaft 14 for biasing the dowel pins 42 away from the wall 34.

The mounting disk 44 is mounted to the free end 54 of the shaft 14 via fasteners 56, a spacer ring 58 being provided between the shaft 14 and mounting disk 44.

As can be better seen in FIG. 4, the mounting disk 44 includes first pairs of facing grooves 60 on the side thereof adjacent the wall portion 34 (for a total of twelve grooves according to the illustrative embodiment). Each groove 60 defines a lodging that receives a spring 46 therein. The pair of grooves 60 ends in a deeper groove 61 that receives a pair of dowel pins 42, each in abutment with a respective spring 46. The pairs of grooves 60 are positioned on the disk 44 at equidistant radial positions. Each groove 60 is oriented to define a slight angle relative to the tangent so that the dowel pin 42 is biased by the spring 46 therein along a similar oriented path.

It has been found that the above-described arrangement of dowel pins 42 and spring 46 contributes to maximizing pressure onto the facing wall portion 34 of the opening 20 of the arm 16.

The mounting disk 44 further includes a plurality of radially equidistant straight grooves 62, which define passages for dowel-contacting fingers 64 of the actuating mechanism 50. Each straight groove 62 ends in a respective groove 61, so that each finger 64 can simultaneously push a pair of dowel pins 42.

The locking assembly 12 further includes a cover disk 66 (shown in dashed line in FIG. 3), that is secured to the mounting disk 44 via fasteners (not shown), which are received in fastener-receiving holes 68 in the disk 44. The cover disk 66 is configured and sized to lock the pins 42 and springs 46 in their respective grooves 60-61 and allows sliding portions 70 of the dowel-contacting fingers 64 to remains and slide in the straight grooves 62, while allowing pivoting portions 72 of the arms in and out of the plane formed by the sliding portions 70.

According to another illustrative embodiment (not shown), mounting and cover disks 44 and 66 is replaced by a similar one-piece body. According to still another illustrative embodiment (not shown), the cover disks 44 and 66 are replaced by another assembly allowing to relatively position and guide the pins 42, springs 46 and fingers 64.

The actuating mechanism 50 will now be described in more detail.

As mentioned hereinabove, the actuating mechanism 50 comprises a plurality of dowel-contacting fingers 64 that are mounted to the shaft 14 via the mounting disk 44, and an actuator rod 74 mounted to the fingers 64 to cause their movement in unison towards and away the pivot arm 16.

The sliding portion 70 of each finger 64 is generally rectangular with two lateral rounded notches 76 at the distal end 78 thereof. As described hereinabove, the sliding portions of the fingers 64 are slidably mounted in the straight grooves 62 of the disk 44 and maintained therein by the cover disk 66.

Each finger 64 of the actuating mechanism 50 further comprises a pivoting portion 72 that is pivotably mounted to proximate end 80 of the sliding portion 70 at one longitudinal end, and pivotably mounted to the actuator rod 74 via a mounting crown 82 at the other longitudinal end.

The pivoting portions 72 of the fingers 64 and the proximate end 80 of the sliding portions 70 are free from both the mounting and cover disks 44 and 66, allowing the pivoting portions 72 to pivot relative to the sliding portions 70 in and out of the plane defined by the mounting disk 44.

The mounting crown 82 is secured at the distal end (not shown) of the actuator rod 74, which is only partially shown in some of the figures so as to alleviate the views.

A person skilled in the art, will now appreciate that moving the actuator rod 74 upwardly, for example via a linear actuator (not shown), within or under the floor-mountable shaft 14, causes the pivoting portions 72 of the fingers 64 to be moved upwardly in unison, in turn, causing the sliding of the sliding portions 70 thereof to be moved away from the dowel pins 42. While in this retracted position of the actuating mechanism 50, which is shown in FIGS. 1 to 3, there is no force exerted unto the dowel pins 42 by the fingers 64, which are then biased by the springs 46 towards the facing wall portion 34 of the opening 20 of the pivot arm 16. The configuration and position of the springs 46 are such that the biasing force is sufficient to prevent the movement of arm 16 relative to the floor-mountable shaft 14.

Conversely, moving the shaft 74 downwardly causes the pivoting portions 72 of the fingers 64 to be moved downwardly in unison, in turn, causing the sliding of the sliding portions 70 thereof, to be moved towards the dowel pins 42, causing the retraction of the dowel pins 42 from the wall 34. While in this extended position

of the actuating mechanism 50, which is shown in FIGS. 5 to 7, a pushing force is exerted on the dowel pins 42, that is beyond the biasing force of the spring 46. Pivoting movements of arm 16 relative to the floor-mountable shaft 14 is then allowed.

According to another illustrative embodiment, the shaft 74 can be mounted upside to the mounting crown 82 so that the results of the operating movements of the shaft 74 are reversed.

According to another illustrative embodiment, the actuator rod 74 and linear actuator are replaced by any other mechanism or assembly allowing moving the crown 82 up and down.

According to still another illustrative embodiment, the pivoting portions 72 of the fingers 64 of the actuating mechanism 50 are embedded in a flexible body (not shown) made, for example, of rubber or of a resilient or semi-rigid elastomeric material. Such a body can be, for example, circular or star-shaped. According to still another illustrative embodiment, both the sliding and pivoting portions 70-72 of the fingers are embedded in such a resilient or semi-rigid body. Such hingeless mechanisms allow reducing the number of articulations in the actuating mechanism, while facilitating its mounting in the locking assembly 12.

It is believed to be within the reach of a person skilled in the art to adapt the number and form of the dowel pins 42, the number of biasing members 46 and the configuration and force thereof so that they allow selective locking of the shaft 14 relative to the arm 16, depending on both their configuration. Similarly, the number and shape of the fingers 64 and their mounting to the shaft 74 can also be adapted to the above.

With reference first to FIGS. 8-10 and 14A, a locking assembly 84 according to a second illustrative embodiment, will now be described. Since the locking assembly 84 is similar to locking assembly 12, only the differences therebetween will be described herein for concision purposes.

The differences between both the locking assemblies 12 and 84 lie in their actuating mechanisms 50 and 86, the latter will now be described hereinbelow in more detail.

In the actuating mechanism 86, the sliding portions of the fingers 64 are replaced by similarly shaped fingers 88, which further includes a rectangular opening therein, defining a lodging 90 for a biasing element in the form of a spring 92.

With reference more specifically to FIG. 14A, a mechanical stop 94 extends from a plate 96 that is fixedly mounted to the shaft 18, and coaxially receives one end 98 of the spring 92 thereabout. This arrangement causes each spring 92 to automatically bias a corresponding finger 88 away from the corresponding pair of dowel pins 42 when no force is exerted onto the finger 88, creating a recall force.

A star-shaped cylindrical block 99 is mounted to the actuator rod 74, coaxial thereto, for reciprocating up and down movements therewith. The block 99 defines a plurality of narrow tapered portions 100 radially outwardly extending therefrom.

Each tapered portion 100 is aligned with a respective finger 88 so as to be in contact therewith. The tapered portions 100 are thicker at the distal (top) end 102 of the block 99 and their thickness gradually and smoothly decreases towards the bottom end (not shown). It results from this configuration of block 99 that, when it is lowered, the block 99 gradually moves the fingers 88 in unison towards the facing wall portion 34 of the opening 20, causing the dowel pins 42 to be pushed away therefrom.

The operation of locking assembly 84, and more specifically of its actuating mechanism 86, will now be described in more detail with references to FIGS. 8 to 13.

As described hereinabove, the actuating mechanism 86 is movable between a first position, shown in FIGS. 8-10 and 14A, which corresponds to the locking assembly 84 preventing the pivot of the pivot arm 16 relative to the shaft 14, and a second position, shown in FIGS. 11-13 and 14B, which corresponds to the locking assembly 84 being disengaged and therefore allowing the pivot of the pivot arm 16 relative to the shaft 14.

The first position of FIGS. 8-10 and 14A is achieved by the actuating rod 74 raising the block 99 to its upper position, resulting in the fingers 88 being biased away from the corresponding pair of dowel pins 42 by the springs 92, and the springs 46 being free to push the dowel pins 42 towards the facing wall portion 34 of the opening 20 of the arm 16, thereby exerting sufficient friction thereon to prevent a relative pivot movement between the two pivot members 14 and 16.

Conversely, the second position of FIGS. 11-13 and 14B is achieved by the actuating pin 74 lowering the block 99 to its lower position, resulting in the fingers 88 being forced towards the corresponding pair of dowel pins 42 by the springs 92, and the springs 46 being prevented from pushing the dowel pins 42 towards the facing wall portion 34 of the opening 20 of the arm 16, removing friction thereon to allow a relative pivot movement between the two pivot members 14 and 16.

It is to be noted that many modifications could be made to the pivot assemblies 10 or to the locking assemblies 12 and 84 therefore, described hereinabove and illustrated in the appended drawings. For example:
the number and arrangement of pressure elements 42 and of biasing members 46 can be different than illustrated. Also, the pressure elements are not limited to being dowel pins and the biasing members 46 and 92 are not limited to being coil springs.

Turning now to FIGS. 15 and 16, an arm coupling assembly 104 will now be described in more detail. The arm coupling assembly 104 links a second pivot assembly 106 to the pivot assembly 10 so that both pivot assemblies 10 and 106 are caused to pivot in unison.

It is to be noted that, since an arm coupling assembly 104 is provided between both pivot assemblies 10 and 106, the locking assembly 12 (or 84) is sufficient in normal condition to lock both pivot assemblies 10 and 106, since the locking of the first pivot assembly 10 will prevent the pivoting of the second assembly 106, considering their coupling. For such reason, a further locking assembly is thereby not required nor provided on the second pivot assembly 106.

However, in case of an accident involving the vehicle (not shown) that includes the multi-pivot seat base assembly 11, a rotational force beyond a specific threshold may be applied onto the pivot assemblies 10 and 106, and therefore of a seat (not shown) coupled to the second pivot assembly 106, from the floor-mountable shaft 14. To prevent such detrimental force to the assembly 11, and more importantly to the person on the seat, an emergency blocking system 108 can also be provided between both pivot assemblies 10 and 106, which will be described hereinbelow in more detail.

The pivot assembly 106 comprises a third pivot member in the form of a shaft 110, and the pivot arm 16 of the multi-pivot seat base assembly 11.

The coupling assembly 104 includes a first sprocket 112 that is mounted to the first pivot assembly 10 about the straight portion 18 of the shaft 14 via first and second spacer rings 114-116, therebetween. More specifically, the lower spacer ring 116 includes an upwardly extending flange 118 that coaxially receives the first sprocket 112 thereabout. The first spacer ring 114 forms half of a fairlead pulley 119 of the emergency blocking system 108, which will be described hereinbelow in more detail.

The coupling assembly 104 further includes a second sprocket 120 that is mounted to the end 122 of the second shaft 110 via a dynamic pulley 124 of the emergency blocking system 108, and a chain 125, engaged to both sprockets 112, 120.

One skilled in the art will understand that since the first sprocket 112 is so mounted to the first pivot assembly 10 and since the second sprocket 120 is so mounted to the second pivot assembly 106 as to pivot therewith, a pivotal movement of the proximate arm 16 about the first pivot axis 128 causes a pivotal movement of the shaft 110 about second pivot axis 129, and of any distal arm mounted thereto (not shown).

It is believed to be within the skills of one skilled in the art to determine the gear ratio between the first and second sprockets 112 and 120 to obtain the desired movement pattern.

The emergency blocking system 108 comprises the fairlead pulley 119, which is fixedly mounted to the proximate arm 16, thereunder, the dynamic pulley 124, which is fixedly mounted to the shaft 110 of the second pivot assembly 106 for solidary rotation therewith, and a flexible tension member, in the form of an endless rope 130, which is operatively mounted to both pulleys 119 and 124, therebetween.

The fairlead pulley 119 is defined by the first spacer ring 114 and a third spacer ring 126, that is fixedly mounted thereto. The third spacer ring 126 includes a downwardly extending rope-guiding flange 132. The pulley 119 is fixedly mounted to the shaft 14 via the spacer ring 116.

The dynamic pulley 124 is fixedly mounted to the second pivot assembly 106 for rotation in unison therewith, and includes a top ring 138, provided with a downwardly extending rope-receiving flange 140, and a bottom plate 142, secured to the top ring 138 at the edge of its flange 140. The bottom side 144 of plate 142 is provided with a downwardly extending inner flange 146, which fixedly receives the second sprocket 120 thereabout. The rope 130 is fixedly mounted to the flange 140 using a fastener 147 or the like.

While the rope is illustrated as being endless, it can be free-ended (not shown) with both free ends thereof attached to the pulley 124.

It is to be noted that the expression “in unison” is to be construed as meaning that the movement of one assembly causes the movement of the other. Such movement can be synchronized or not.

The emergency blocking system 108 further includes blocking cleats, in the form of four (4) rounded spacers 148, that are mounted to both spacer rings 114 and 126, therebetween. The blocking cleats 148 are positioned in pairs, each pair defining a passage for the rope 130 in/out of the fairlead pulley 119, the passages being tangentially offset inwardly.

At least one cleat 148 in each adjacent pair of cleats 148 is movable towards and away the other cleat 148 between a neutral position wherein a rotation of the dynamic pulley 124 via the flexible tension member 130 is prevented and a forced position wherein the rotation of the dynamic pulley 124 is allowed. For that purpose, the blocking cleats 148 are mounted to both the first spacer ring 114 and the mounting flange 134, therebetween, via mounting pins (not shown), which are received in oblong holes 149 for translation therein.

Biasing members (not shown) are used to force the cleats 148 towards their neutral, default, position so that the flexible tension member 130 remains blocked unless a mechanism (not shown) is actuated.

Such a mechanism includes biasing members (not shown), in the form for example of actuating levers (not shown), which force the blocking cleats away each other.

As can also be seen in FIG. 16, the pin-receiving holes 151 in the cleats 148 are offset from their center, allowing a cam movement thereof.

A person skilled in the art will now appreciate that the friction members 148 allow preventing a rotation of both first and second pivot assemblies 10 and 106 via the flexible tension member 130 when an actuating mechanism is released. It results that blocking system 108 ensures the safety and stability of the seat base in extreme situations, for example following breakage of the locking assembly 12 or 84, thereby preventing unwanted rotations.

According to another illustrative embodiment, the locking assemblies 12 or 84 are omitted and the blocking system 108 functions as the only blocking system.

The rope 130 is made of Vectran™ or of another resistant material, such as without limitations Dyneema™ and nylon. According to another illustrative embodiment, the rope 130 is replaced by a strap.

Also, according to another embodiment (not shown), the position and configuration of the friction members are different than illustrated.

It is to be understood that the pivot and locking assemblies, blocking system and a multi-pivot seat base assembly therewith are not limited in their application to the details of construction and parts illustrated in the accompanying drawings and described hereinabove. The pivot and locking assemblies, emergency blocking system and a multi-pivot seat base assembly therewith are capable of other embodiments and of being practiced in various ways. It is also to be understood that the phraseology or terminology used herein is for the purpose of description and not limitation. Hence, although the pivot and locking assemblies, emergency blocking system and a multi-pivot seat base assembly therewith have been described hereinabove by way of illustrative embodiments thereof, it can be modified, without departing from the spirit, scope and nature thereof.

What is claimed is:

1. A locking assembly for a pivot assembly that includes a first pivot member having a circular opening therein, and a second pivot member having a first shaft coaxially mounted in the circular opening of the first pivot member for relative pivot movement of the first and second pivot members, the locking assembly comprising:
pressure elements mounted, within the circular opening, to one of the first and second pivot members; the pressure elements being biased towards the other one of the first and second pivot members to prevent said relative pivot movement; and
an actuating mechanism, mounted to the pressure elements, that selectively moves the pressure elements away from the other one of the first and second pivot members.

2. The locking assembly as recited in claim 1, wherein the pressure elements are in the form of dowel pins mounted to the second pivot member in the circular opening via a mounting disk.

3. The locking assembly as recited in claim 2, further comprising biasing elements mounted to the mounting disk for biasing the dowel pins towards the first pivot member.

4. The locking assembly as recited in claim 3, wherein the mounting disk includes peripheral lodgings for mounting both biasing elements and the dowel pins so that the biasing elements biased the dowel pins outwardly of the mounting disk.

5. The locking assembly as recited in claim 3, wherein the biasing elements include at least one spring.

6. The locking assembly as recited in claim 3, wherein the actuating mechanism includes dowel-contacting fingers mounted to the mounting disk for movements towards and away from the dowel pins.

7. The locking assembly as recited in claim 6, wherein the actuating mechanism further includes an actuating element coupled to the dowel-contacting fingers and that is movable between a neutral locking position to an unlocking position, wherein the dowel-contacting fingers releases pressure exerted by the biasing elements onto the dowel pins.

8. The locking assembly as recited in claim 7, wherein dowel pins are mounted in peripheral substantially facing pairs; each dowel-contacting finger is mounted to the mounting disk for operating simultaneously on both dowel pins of a respective facing pair thereof.

9. The locking assembly as recited in claim 7, wherein the actuating element includes a second shaft mounted to the first shaft so as to be movable therein; each of the dowel-contacting fingers including a pivoting portion pivotably mounted to the second shaft and a sliding portion pivotably mounted to the pivoting portion and being at least partially inserted in the mounting disk for said movements towards and away from the dowel pins.

10. The locking assembly as recited in claim 8, wherein the mounting disk includes finger-receiving grooves; the locking assembly further comprising a ring cover secured to the mounting disk and defining, with the finger-receiving grooves, finger-receiving channels that allow reciprocating movements of the sliding portion therein.

11. The locking assembly as recited in claim 7, wherein the dowel-contacting fingers are assembled to the actuating element in a star configuration thereon.

12. The locking assembly as recited in claim 7, wherein the actuating element includes a block mounted to the mounting disk for reciprocating movement therethrough; the block including a plurality of tapered portions extending outwardly therefrom so that each tapered portion is aligned with a respective dowel-contacting finger; the block being reciprocable between:
a) an unlocking position, that forces the respective dowel-contacting finger unto a respective dowel pin so as to release pressure exerted by a corresponding biasing element unto the respective dowel pin; and
b) a neutral locking position, wherein the biasing element is free for said biasing the dowel pins towards the first pivot member.

13. The locking assembly as recited in claim 12, wherein the biasing elements includes springs, each mounted to both a respective dowel-contacting finger and the first shaft therebetween.

14. The locking assembly as recited in claim 1, wherein the actuating mechanism is mounted to the first shaft.

15. A pivot seat base assembly comprising:
first and second pivot assemblies;
a blocking system comprising:
a) a fairlead pulley fixedly mounted to the first pivot assembly;
b) a dynamic pulley fixedly mounted to the second pivot assembly;
c) a flexible tension member that is operatively mounted to both the fairlead and dynamic pulleys therein; and
d) blocking cleats mounted to the fairlead pulley for movement between a default position, wherein a rotation of the dynamic pulley via the flexible tension member is prevented, and an actuated position, wherein the rotation of the dynamic pulley is allowed;
wherein, one of the first and second pivot assemblies including a locking assembly as recited in claim 1.

16. A pivot assembly comprising:
a) a first pivot member having a circular opening therein,
b) a second pivot member having a first shaft coaxially mounted in the circular opening of the first pivot member for relative pivot movement of the first and second pivot members;
c) pressure elements mounted, within the circular opening, to one of the first and second pivot members; the pressure elements being biased towards the other one of the first and second pivot members to prevent said relative pivot movement; and
d) an actuating assembly, mounted to the pressure elements, that selectively moves the pressure elements away from the other one of the first and second pivot members.

17. The pivot assembly as recited in claim 16, wherein the second pivot member is a floor-mountable shaft, and the first pivot member is a pivot arm.

18. The pivot assembly as recited in claim 16, which is part of a multi-pivot seat base assembly.

19. The pivot assembly as recited in claim 18, wherein the multi-pivot seat base assembly is in an emergency vehicle.

20. A blocking system for a pivot seat base assembly having first and second pivot assemblies; the emergency blocking system comprising:
a) a fairlead pulley fixedly mounted to the first pivot assembly;
b) a dynamic pulley fixedly mounted to the second pivot assembly;
c) a flexible tension member that is operatively mounted to both the fairlead and dynamic pulleys therein; and
d) blocking cleats mounted to the fairlead pulley for movement between a default position, wherein a rotation of the dynamic pulley via the flexible tension member is prevented, and an actuated position, wherein the rotation of the dynamic pulley is allowed.

21. The blocking system as recited in claim 20, wherein the flexible tension member is a rope.

22. The blocking system as recited in claim 21, wherein the rope is made of a material selected from the group consisting of Vectran™, Dyneema™ and nylon.

23. The blocking system as recited in claim 20, further comprising a coupling assembly mounted to both first and second pivot assemblies, therebetween, to cause the rotation of both first and second pivot assemblies in unison.

24. A multi-pivot seat base assembly comprising:
a pivot arm, first and second pivot assemblies mounted at respective first and second longitudinal end of the pivot arm, and a coupling assembly mounted to both first and second pivot assemblies, therebetween, to cause the rotation of both first and second pivot assemblies in unison;
one of the first and second pivot assemblies including:
a) a first pivot member having a circular opening therein,
b) a second pivot member having a first shaft coaxially mounted in the circular opening of the first pivot member for relative pivot movement of the first and second pivot members;
c) dowel pins mounted to the second pivot member, within the circular opening, via a mounting disk; each dowel pin being biased towards the first pivot member by a spring to prevent said relative pivot movement; and
d) an actuating mechanism, including:
i) dowel-contacting fingers, each coupled to a respective dowel pin to selectively move the respective dowel pin away from the first pivot member, thereby allowing said relative pivot movement;
ii) an actuating element coupled to the dowel-contacting fingers and that is movable between a neutral locking position to an unlocking position, wherein the dowel-contacting fingers releases pressure of the biasing elements unto dowel-pins;
each spring being mounted to both a respective dowel-contacting finger and the second pivot member;
a fairlead pulley fixedly mounted to the pivot arm at the first longitudinal end thereof, coaxial to one of the first and second pivot assemblies;
a dynamic pulley fixedly mounted to the other one of the first and second pivot assemblies for rotation in unison therewith;
a flexible tension member that is endlessly mounted to both the fairlead and dynamic pulleys therein;
blocking cleats mounted to the fairlead pulley for movement between a neutral position, wherein a rotation of the dynamic pulley via the flexible tension member is prevented, and a forced position, wherein the rotation of the dynamic pulley is allowed.
